(19) United States
(12) Patent Application Publication
(10) Pub. No.: US 2026/0101311 A1
(43) Pub. Date: Apr. 9, 2026

(54) METHOD FOR SIDELINK-AIDED MULTI-ROUND TRIP TIME POSITIONING WITHOUT A SERVING GNB

(71) Applicant: Continental Automotive Technologies GmbH, Hannover (DE)

(72) Inventors: Reuben George Stephen, Singapore (SG); David Gonzalez Gonzalez, Egelsbach (DE); Rikin Shah, Langen (DE)

(73) Assignee: Continental Automotive Technologies GmbH, Hannover (DE)

(21) Appl. No.: 19/116,019

(22) PCT Filed: Sep. 26, 2023
(86) PCT No.: PCT/EP2023/076531

§ 371 Date: Mar. 27, 2025

(30) Foreign Application Priority Data
Sep. 27, 2022 (SG) 10202251183A

(51) Int. Cl. H04W 64/00; H04L 5/00; H04W 92/18

(52) U.S. Cl. CPC H04W 64/00; H04L 5/0051; H04W 92/18

(57) ABSTRACT

Methods for sidelink-Aided multi-Round Trip Time Positioning (RTT) in the absence of a serving gNB in a wireless communication system is characterized by, that single-sided or double-side multi-round trip time (RTT)—of wireless communication signals—based positioning involving the sidelink (SL) in the wireless communication system is proceeded by using an initiator node and the position of a target user equipment (UE) is computed.

### CROSS-REFERENCE TO RELATED APPLICATIONS

The present application is a National Stage Application under 35 U.S.C. § 371 of International Patent Application No. PCT/EP2023/076531 filed on Sep. 26, 2023, and claims priority from Singapore Patent Application No. 10202251183A filed on Sep. 27, 2022, in the Intellectual Property Office of Singapore, the disclosures of which are herein incorporated by reference in their entireties.

### TECHNICAL FIELD

The present disclosure relates generally to wireless communications and more particularly Sidelink-Aided Multi-Round Trip Time Positioning. Wireless communication systems have developed through various generations, including a first-generation analog wireless phone service (1G), a second-generation (2G) digital wireless phone service (including interim 2.5G networks), a third-generation (3G) high speed data, Internet-capable wireless service and a fourth-generation (4G) service (e.g., LTE or WiMax). There are presently many different types of wireless communication systems in use, including cellular and personal communications service (PCS) systems. Examples of known cellular systems include the cellular Analog Advanced Mobile Phone System (AMPS), and digital cellular systems based on code division multiple access (CDMA), frequency division multiple access (FDMA), time division multiple access (TDMA), the Global System for Mobile access (GSM) variation of TDMA, etc.

### BACKGROUND

A fifth generation (5G) wireless standard, referred to as New Radio (NR), enables higher data transfer speeds, greater numbers of connections, and better coverage, among other improvements. The 5G standard, according to the Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large wireless deployments. Consequently, the spectral efficiency of 5G mobile communications should be significantly enhanced compared to the current 4G standard. Furthermore, signaling efficiencies should be enhanced and latency should be substantially reduced compared to current standards.

Leveraging the increased data rates and decreased latency of 5G, among other things, vehicle-to-everything (V2X) communication technologies are being implemented to support autonomous driving applications, such as wireless communications between vehicles, between vehicles and the roadside infrastructure, between vehicles and pedestrians, etc.

Obtaining accurate position information for user equipment, such as cellular telephones or other wireless communication devices, is becoming prevalent in the communications industry. For example, obtaining highly accurate locations of vehicles or pedestrians is essential for autonomous vehicle driving and pedestrian safety applications.

A common means to determine the location of a device is to use a satellite positioning system (SPS), such as the well-known Global Positioning Satellite (GPS) system or Global Navigation Satellite System (GNSS), which employ a number of satellites that are in orbit around the Earth. In certain scenarios, however, location determination signals from an SPS may be unreliable or unavailable, e.g., during adverse weather conditions or in areas with poor satellite signal reception such as tunnels or parking complexes. Moreover, position information generated using SPS is prone to imprecision. For example, off-the-shelf GPS positioning devices have an accuracy of a few meters, which is not optimal to ensure safe autonomous driving and navigation.

Coordinated or automated driving requires communications between vehicles, which may be direct or indirect, e.g., via an infrastructure component such as a roadside unit (RSU). For vehicle safety applications, both positioning and ranging are important. For example, vehicle user equipments (UEs) may perform positioning and ranging using sidelink signaling, e.g., broadcasting ranging signals for other vehicle UEs or pedestrian UEs to determine the relative location of the transmitter. An accurate and timely knowledge of the relative locations or ranges to nearby vehicles, enables automated vehicles to safely maneuver and negotiate traffic conditions. Round trip time (RTT), for example, is a technique commonly used for determining a range between transmitters. RTT is a two-way messaging technique in which the time between sending a signal from a first device to receiving an acknowledgement from a second device (minus processing delays) corresponds to the distance (range) between the two devices. While RTT is accurate, it would be desirable to reduce the power consumption required by two way messaging.

Wireless communication systems are widely deployed to provide various telecommunication services such as telephony, video, data, messaging, positioning, and broadcasts. Typical wireless communication systems may employ multiple-access technologies capable of supporting communication with multiple users by sharing available system resources (e.g., bandwidth, transmit power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems.

A wireless multiple-access communication system may include a number of base stations, each simultaneously supporting communication for multiple communication devices, otherwise known as user equipment (UEs). In LTE or LTE-A network, a set of one or more base stations may define an e NodeB (eNB). In other examples (e.g., in a next generation or 5G network), a wireless multiple access communication system may include a number of distributed units (DUs) (e.g., edge units (EUs), edge nodes (ENs), radio heads (RHs), smart radio heads (SRHs), transmission reception points (TRPs), etc.) in communication with a number of central units (CUs) (e.g., central nodes (CNs), access node controllers (ANCs), etc.), where a set of one or more distributed units, in communication with a central unit, may define an access node (e.g., a new radio base station (NR BS), a new radio node-B (NR NB), a network node, 5G NB, gNB, etc.). A base station or DU may communicate with a set of UEs on downlink channels (e.g., for transmissions from a base station or to a UE) and uplink channels (e.g., for transmissions from a UE to a base station or distributed unit). Additionally, UEs may communicate directly with each other using sidelink channels.

The location of UE may be useful or essential to a number of applications including emergency calls, navigation, direction finding, asset tracking and Internet service. The location of a UE may be estimated based on information gathered from various systems. In a cellular network implemented according to LTE or 5G NR, for example, a base station may send downlink reference signals with which positioning measurements are performed by a UE and/or the UE may send uplink reference signals with which positioning measurements are performed by the base stations. Additionally, sidelink reference signals may be transmitted by UEs and positioning measurements performed by a UE. The E may compute an estimate of its own location using the positioning measurements in UE-based positioning or may send the positioning measurements to a network entity, e.g., location server, which may compute the PE location based on the positioning measurements in UE-assisted positioning.

Various positioning techniques can be employed for determining the position of a wireless communication device (e.g., a wireless local area network (WLAN) device) based on receiving wireless communication signals. For example, positioning techniques can be implemented that utilize time of arrival (TOA), the round trip time (RTT) of wireless communication signals, received signal strength indicator (RSSI), or the time difference of arrival (TDOA) of the wireless communication signals to determine the position of a wireless communication device in a wireless communication network. These positioning techniques are dependent on precise time measurements and therefore may be sensitive to variations in hardware and/or software configurations of the wireless communication devices. The accuracy of the positioning results may vary, for example, based on device model, software version, or manufacturer.

It may be desirable for positioning improvements implemented in newer technologies, such as 5G NR, to assist in positioning of multiple UEs more efficiently.

The type of TOA measurement described by that two-way ranging and requester sends a request packet to the responder, which replies after a response time Rj with a response packet and therefore the time lapse between instant when signal is transmitted and instant when response to transmitted signal received can be calculated. Ideally RTT=2×TOA and this means that no synchronization requirements between transmitter and receiver need to be supplied. This means in practice RTTᵢ=Tᵢ(t₃)−Tᵢ(t₀). FIG. 1c shows double-sided two-way ranging (Double-sided RTT). Extra reply sent by node i to j, node j can then calculate RTTⱼ, and in this case residual error is lower than conventional two-way ranging (RTT).

Multi-RTT and the serving cell RTT measurement process is explained. In the first time frame, i, the gNB measures its Rx-Tx time difference and sees it is different from zero. Thus, it sends a timing advance adjustment command to the mobile device. In time frame i+1, the uplink timing of the mobile device is corrected and the gNB Rx-Tx time difference is zero. Hence, the UE Rx-Tx time difference is exactly the RTT. Positioning method introduced in 5G NR and defines procedure to perform RTT measurements on neighbor base stations, enabling trilateration

The aeasurements reported to the Location Management Function (LMF):
A: UE reports t₃−t₀
B: gNB reports t₂−t₁
LMF calculates RTT by

$$RTT = A - B = ( {t}_{3} - {t}_{0} ) - ( {t}_{2} - {t}_{1} )$$

RTT measurement process to the serving base station and RTT measurement process to neighbor base stations is proceeded.

In this context Target UE means UE to be positioned (in this context, using SL, i.e., PC5 interface) and Anchor UE means UE supporting positioning of target UE, e.g., by transmitting and/or receiving reference signals for positioning, providing positioning-related information, etc., over SL interface and Sidelink positioning means Positioning UE using reference signals transmitted over SL, i.e., PC5 interface, to obtain absolute position, relative position, or ranging information and Ranging means determination of the distance and/or the direction between a UE and another entity, e.g., anchor UE.

Now the absolute positioning based on multi-RTT the existing Multi-RTT distance-based absolute positioning based on multi-RTT is described and if it is possible if there are at least three neighboring gNBs. If not enough neighboring gNBs are existing, absolute positioning with multi-RTT cannot be performed. FIG. 1b shows Sidelink-Aided Multi-RTT without gNB Using sidelink (SL) for multi-RTT solves this problem.

Straightforward approach to include SL: RTT signals and measurements to be exchanged between each anchor node and target UE individually; drawbacks the need to allocate resources for SL-PRS, measurement reporting, etc. separately for each anchor UE and with current SL resource allocation (especially in mode 2) target and anchor UEs need to sense and transmit over SL for each RTT measurement. This means the need of efficient resource allocation and message exchange protocols for sidelink-aided multi-RTT when serving gNB isn't involved.

US 2022150863 A1 discloses a method being performed by a first station and comprises: transmitting a first message including an indication of whether a clock reconfiguration event occurs at the first station; transmitting a first positioning reference signal (PRS); receiving from a second station a second PRS; and transmitting to the second station a second message including a first time when the first PRS is transmitted by the first station and a second time when the second PRS is received by the first station, to enable the second station to determine a roundtrip time (RTT) between the first station and the second station based on the first time, the second time, a third time when the second station receives the first PRS, a fourth time when the second station transmits the second PRS, and the indication.

WO 2022027298 A1 discloses that a UE transmits an SL RTT measurement request to at least one UE. The UE communicates (e.g., transmits, receives, or both), with the at least one UE in response to the SL RTT measurement request, an indication of an SL RTT measurement (e.g., Rx-Tx time difference measurement for RTT).

WO 2020256311 A1 discloses a method of operating a first terminal in a wireless communication system. The method may comprise: a step for transmitting a first PRS to a second terminal; a step for receiving a second PRS from the second terminal; a step for receiving a first time difference from the second terminal; and a step for determining a location of the first terminal on the basis of the first time difference and a second time difference.

WO 2021188220 A1 discloses techniques for wireless communication. In an aspect, a first user equipment (UE) transmits a request to perform a positioning procedure to at least one second UE over a sidelink between the first UE and the at least one second UE, receives, from the at least one second UE over the sidelink, an indication of a set of time resources, frequency resources, or both allocated for the positioning procedure, and transmits at least one positioning reference signal on the set of time and/or frequency resources allocated for the positioning procedure. The second UE receives the request to perform a positioning procedure from the first UE over the sidelink; transmits the request to perform the positioning procedure to a first network entity; receives, from a second network entity, an indication of a set of time resources, frequency resources, or both allocated for the positioning procedure; and transmits the indication to the first UE over the sidelink.

WO 2021167393 A1 a method for performing positioning in a cellular-vehicle to everything (C-V2X) system, and a device therefor. A method for performing positioning in a terminal mounted on a positioning vehicle in a C-V2X communication system according to one aspect may comprise the steps of: measuring a time of flight (ToF) by performing road side unit (RSU) and round trip time (RTT) ranging; determining a positioning mode, wherein the positioning mode includes a self-positioning mode and a cooperative positioning mode; measuring the relative positions of surrounding vehicles by using a sensor provided in the positioning vehicle on the basis of the determined positioning mode being the cooperative positioning mode, and storing first positioning measurement information corresponding to the measured relative positions; selecting a surrounding vehicle on which to perform cooperative positioning; transmitting the first positioning measurement information to the selected surrounding vehicle; receiving second positioning measurement information from the selected surrounding vehicle; and determining the current location of the positioning vehicle on the basis of the first and second positioning measurement information.

WO 2022041130 A1 discloses an apparatus comprising: an interface; a memory; and a processor, communicatively coupled to the interface and the memory, configured to: instruct a node to send a first cellular reference signal to a target UE (user equipment) and to another UE, the node being a cellular-communication node; instruct, via the interface, the target UE to report to the node a first time difference, the first time difference being a first time amount between receipt of the first cellular reference signal by the target UE and transmission of a second cellular reference signal by the target UE; and instruct, via the interface, the other UE to report a second time difference, the second time difference being a second time amount between receipt of the first cellular reference signal by the other UE and receipt of the second cellular reference signal, in a cross-link interference resource, by the other UE.

WO 2021138127 A1 discloses techniques for positioning a NR bandwidth-limited user equipment (UE) are provided. An example method of positioning performed by a bandwidth-limited UE includes transmitting a first timing measurement signal to at least one proximate premium UE, wherein the at least one proximate premium UE is capable of using more bandwidth than the bandwidth-limited UE, receiving a second timing measurement signal from the at least one proximate premium UE, and determining location information for the bandwidth-limited UE based at least on the first timing measurement signal and the second timing measurement signal.

WO 2021118756 A1 discloses techniques for positioning a bandwidth-limited user equipment (UE) are provided. An example method of positioning performed by a bandwidth-limited UE according to the disclosure includes receiving a first timing measurement signal from at least one proximate UE, wherein the at least one proximate UE is capable of using more bandwidth than the bandwidth-limited UE, and transmitting a second timing measurement signal to the at least one proximate user equipment.

US 2021306979 A1 discloses Systems, methods, and devices for sidelink positioning determination and communication employing techniques including obtaining, at a first sidelink-enabled device, data from one or more data sources indicative of one or more criteria for using either round-trip time (RTT)-based positioning of a target node or single-sided (SS)-based positioning of the target node. The techniques also include selecting, with the first sidelink-enabled device, a positioning type from the group may comprise of RTT-based positioning and SS-based positioning, based on the data. The techniques also include sending a message from the first sidelink-enabled device to a second sidelink-enabled device, where the message includes information indicative of the selected positioning type.

WO 2022126496 A1 discloses devices, methods, apparatuses and computer readable storage media of retransmission of sidelink positioning reference signal (PRS). The method comprises transmitting, to a second device, a first sidelink reference signal associated with a positioning or ranging procedure of the first device; and receiving, from the second device, a second sidelink reference signal associated with the positioning or ranging procedure, the second sidelink reference signal comprising information indicating whether the first sidelink reference signal needs to be retransmitted. In this way, the retransmission of the sidelink PRS can be triggered without extra resource consumption and a fast RTT estimation for sidelink ranging and positioning can be achieved.

US 2018098299 A1 discloses a method by which a user equipment (UE) performs ranging in a wireless communication system, comprising the steps of: transmitting a D2D signal in a subframe N by a first UE; receiving the D2D signal in a subframe N+K from a second UE, which has set, as a subframe boundary, a time point at which the D2D signal is received; and measuring, by the first UE, a round trip time (RTT) by detecting a reception time point of the D2D signal transmitted by the second UE.

US 2021377907 A1 discloses techniques for sidelink positioning with a single anchor using distributed antenna systems. An example method for determining relative locations of two stations includes determining a first round trip time for positioning reference signals transmitted between a first station and a first antenna of a second station, determining a second round trip time for the positioning reference signals transmitted between the first station and a second antenna of the second station, wherein the first antenna and the second antenna are disposed in different locations proximate to the second station, and determining relative locations of the first station and the second station based at least in part on the first round trip time and the second round trip time.

US 2022244344A1 discloses an approach to obtain the positions of multiple user equipments (UEs), which are jointly determined by a location server using positioning measurements from a comment set of positioning reference signals (PRS), which may include downlink (DL) PRS, uplink (UL) PRS, sidelink (SL) PRS, or a combination thereof. The common set of PRS may be selected by the location server, e.g., based on a rough estimate of position of the UEs determined by the location server, a recommendation from the UEs, or a position report from the UEs. Once selected by the location server, an indication of the common set of PRS is sent to the UEs. The common set of PRS, alternatively, may be selected by one or more UEs, e.g., by a controlling UE or consensus, and one or more UEs provide an indication of the common set of PRS to the location server.

All cited prior art is based on sidelink-based positioning augmentation and RTT, but none on multi-RTT or double-sided multi-RTT. Currently, there is no way to perform multi-RTT using sidelink. Even when serving gNB is involved, SL-based multi-RTT can be useful since it provides access to additional anchor UE(s) when there are not enough neighbor gNBs or to improve accuracy of existing positioning methods. Individual uncoordinated RTT measurements to each anchor UE are time consuming and therefore the solution of this problem is given by performing multi-RTT efficiently when using SL signals.

The used terminology is defined by:
Target UE means UE to be positioned (in this context, using SL, i.e., PC5 interface)
Anchor UE means UE supporting positioning of target UE, e.g., by transmitting and/or receiving reference signals for positioning, providing positioning-related information, etc., over SL interface.

Sidelink positioning means positioning UE using reference signals transmitted over SL, i.e., PC5 interface, to obtain absolute position, relative position, or ranging information.

Ranging means determination of the distance and/or the direction between a UE and another entity, e.g., anchor UE

Currently there is no solution given how to perform multi-RTT using SL. When serving gNB is not involved, SL-based multi-RTT is the only way to perform absolute positioning using RTT. SL-based multi-RTT can also improve accuracy of existing positioning methods. Individual uncoordinated RTT measurements to each UE are time consuming and there this application provides a solution for performing multi-RTT efficiently when using SL signals without any gNB coordination.

Currently is protocol existing for SL-based multi-RTT, and this application provides a method for SL-based multi-RTT without any gNB involvement. This application provides methods to flexibly choose the nodes for multi-RTT. And it provides furthermore methods for continuing or terminating multi-RTT. By using these methods initiating node can access nodes that were not directly reachable to it for multi-RTT and it supports both single-sided and double-sided multi-RTT, which would be more important when SL is involved. Both target UE initiated, and anchor UE initiated methods operate similarly and have their own advantages depending on the capabilities and requirements of the UEs.

### BRIEF DESCRIPTION OF THE DRAWINGS

FIG. 1 shows absolute positioning based on multi-RTT.

FIG. 1a shows the existing Multi-RTT.

FIG. 1b shows Sidelink-based Multi-RTT without Gnb.

FIG. 2 shows the initiator when no Serving gNB is involved.

FIG. 2a shows Target UE initiator.

FIG. 2b shows LMF/gNB initiator.

FIG. 3 shows the flowchart of Target UE initiator.

FIG. 4 shows the continuation of the flowchart of serving Target UE initiator.

### DETAILED DESCRIPTION

The detailed description set forth below, with reference to annexed drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In particular, although terminology from 3GPP 5G NR may be used in this disclosure to exemplify embodiments herein, this should not be seen as limiting the scope of the invention.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

In some embodiments, a more general term “network node” may be used and may correspond to any type of radio network node or any network node, which communicates with a UE (directly or via another node) and/or with another network node. Examples of network nodes are NodeB, MeNB, ENB, a network node belonging to MCG or SCG, base station (BS), multi-standard radio (MSR) radio node such as MSR BS, eNodeB, gNodeB, network controller, radio network controller (RNC), base station controller (BSC), relay, donor node controlling relay, base transceiver station (BTS), access point (AP), transmission points, transmission nodes, RRU, RRH, nodes in distributed antenna system (DAS), core network node (e.g. Mobile Switching Center (MSC), Mobility Management Entity (MME), etc), Operations & Maintenance (O&M), Operations Support System (OSS), Self Optimized Network (SON), positioning node (e.g. Evolved-Serving Mobile Location Centre (E-SMLC)), Minimization of Drive Tests (MDT), test equipment (physical node or software), etc.

In some embodiments, the non-limiting term user equipment (UE) or wireless device may be used and may refer to any type of wireless device communicating with a network node and/or with another UE in a cellular or mobile communication system. Examples of UE are target device, device to device (D2D) UE, machine type UE or UE capable of machine to machine (M2M) communication, PDA, PAD, Tablet, mobile terminals, smart phone, laptop embedded equipped (LEE), laptop mounted equipment (LME), USB dongles, UE category M1, UE category M2, ProSe UE, V2V UE, V2X UE, etc.

Additionally, terminologies such as base station/gNodeB and UE should be considered non-limiting and do in particular not imply a certain hierarchical relation between the two; in general, “gNodeB” could be considered as device 1 and “UE” could be considered as device 2 and these two devices communicate with each other over some radio channel. And in the following the transmitter or receiver could be either gNodeB (gNB), or UE.

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc readonly memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment. Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the flowchart diagrams and/or block diagrams.

The flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

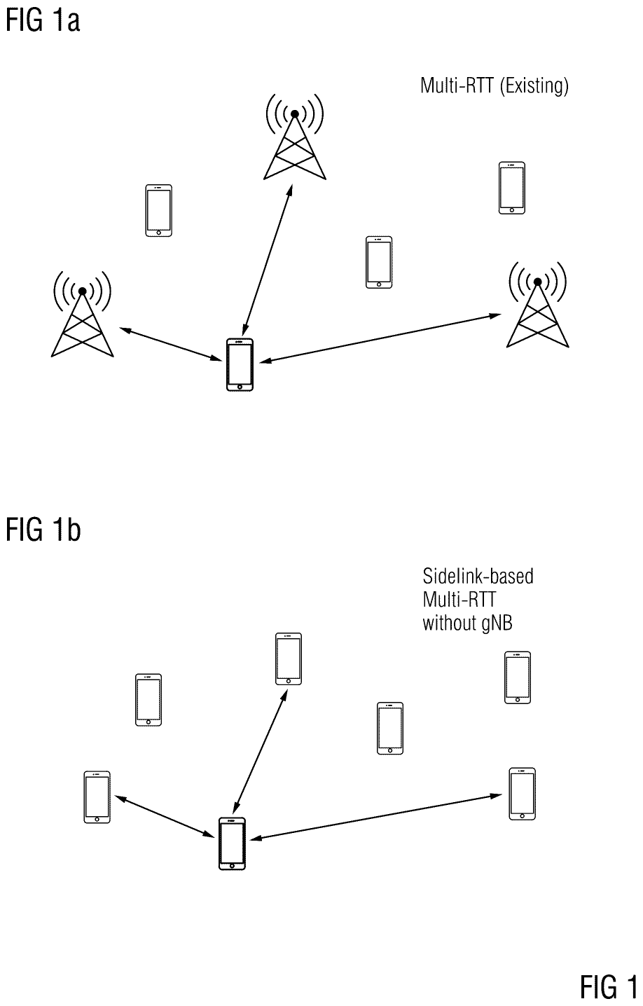

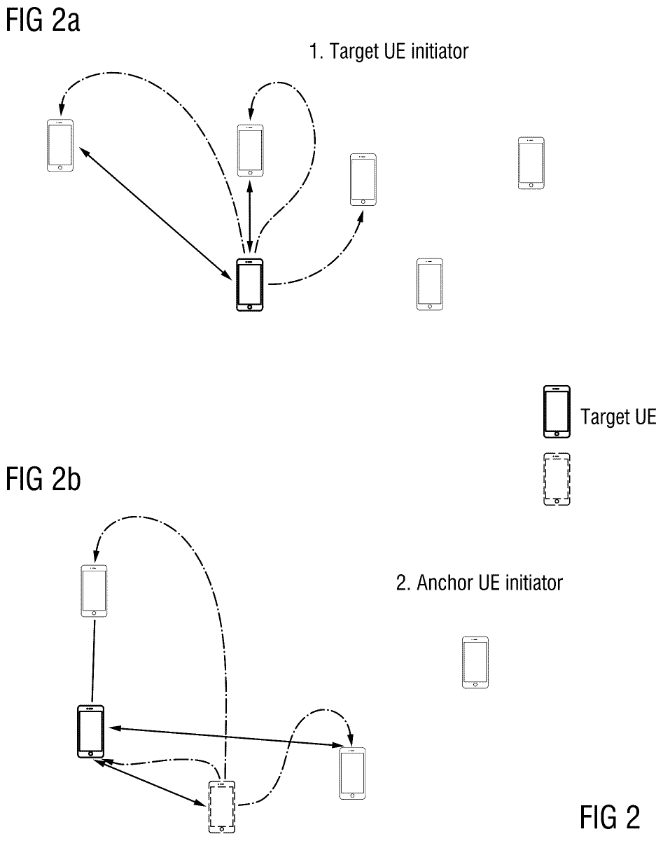

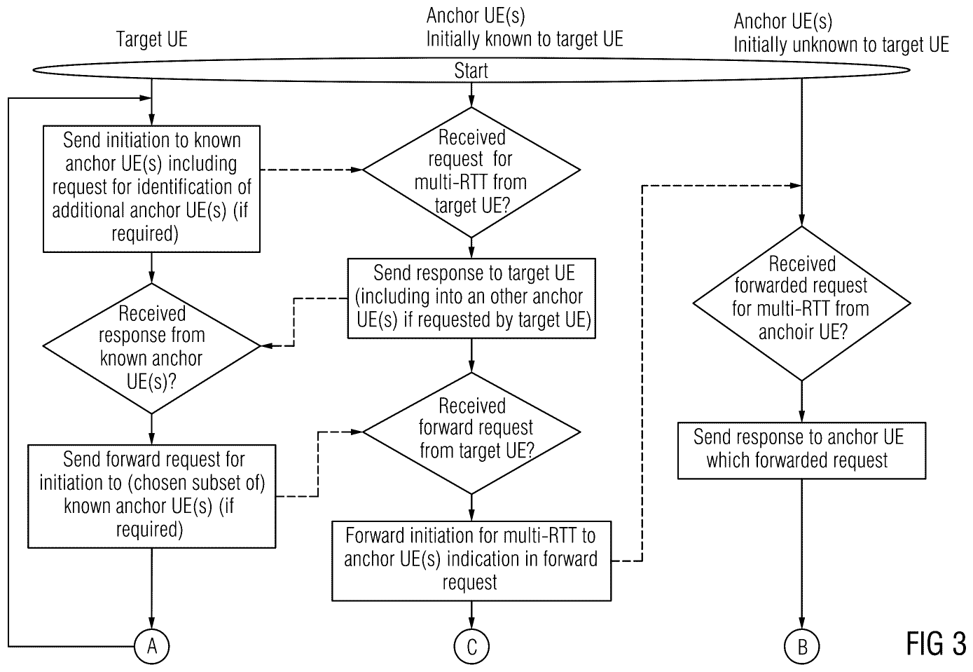

FIGS. 1 to 4 have already been described within the introduction.

By this application a method to enable single-sided or double-side multi-RTT-based positioning based pm signal/message exchange over the SL without involvement of any gNB is proposed.

The solution involves three novel components. An initiator node which is responsible for identifying the anchor UE(s) and gNB(s) to be involved in the multi-RTT positioning and forwarding any resource allocation for positioning to the nodes. Furthermore a method by which the initiator can seek additional nodes for participation in multi-RTT when there are not enough nodes already known to it and a method to identify the right anchor UE(s) to be included in the multi-RTT procedure by sharing the accuracy requirement, and gracefully terminate the multi-RTT procedure if required by progressively reducing the accuracy requirement.

Beneficially, this application provides for initiator to flexibly choose the nodes for multi-RTT. When target UE is initiator, solution enables discovery of anchor UE(s) and neighbor gNB(s) not directly known to target UE at first, while also eliminating redundant message exchange. Furthermore, thus application provides a mechanism for continuing or terminating multi-RTT in case there are not enough nodes available for multi-RTT with desired accuracy and provides a way to perform either single-sided or double-sided multi-RTT.

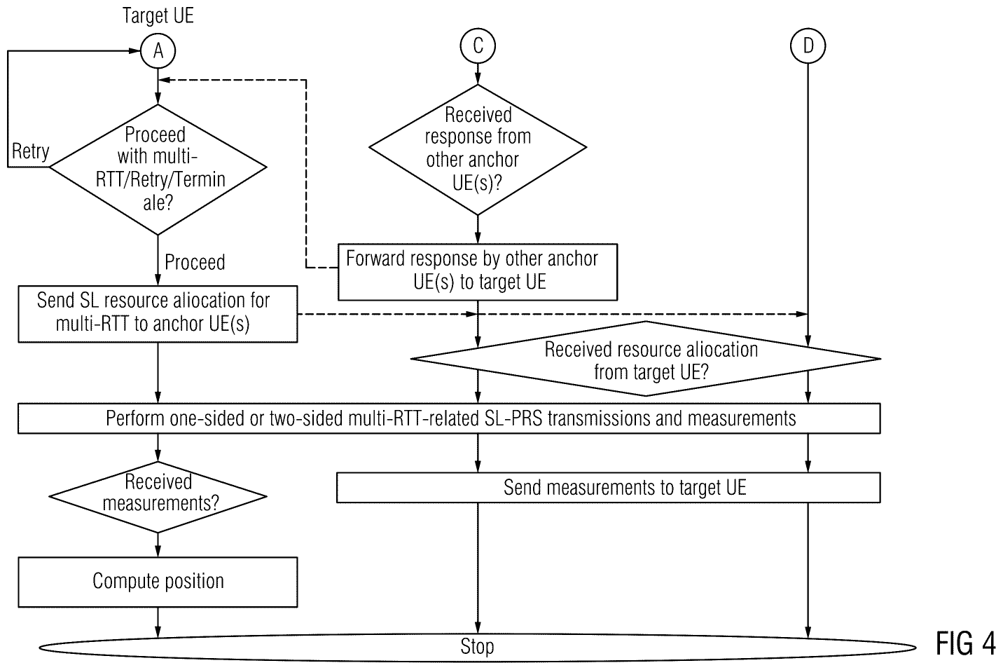

FIG. 4 shows the initiator when no Serving gNB is involved.

FIG. 4a shows Target UE initiator.

FIG. 4b shows Anchor UE Initiator.

FIG. 5 shows the flowchart of serving Target UE initiator.

FIG. 6 shows the continuation of the flowchart of serving Target UE initiator.

Initiator is chosen by positioning protocol/higher layer depending on position requirement, e.g., if target UE itself needs to compute its position, it can initiate the procedure; else if an anchor UE (e.g., an RSU) requires the position of a target UE, the anchor UE can initiate the procedure. The general procedure proposed for performing multi-RTT is similar for both cases. Message exchanges between the nodes involved in the multi-RTT procedure can be performed over a new dedicated SL positioning protocol or directly using physical layer signaling (SCI and/or PSSCH).

Like it is depicted in FIG. 4a and in FIG. 5 and all the depicted flows named A, C, D are illustrating the functional interaction and the components of the wireless communication system. As it can be seen the components are Target UE, anchor UE(s) initially known to target UE and anchor UE(s) initially unknown to target UE.

Initiation is transmitted to known anchor UE(s); to each known anchor UE, initiation message includes at least a Type of RTT positioning (single-sided or double sided), accuracy requirement for anchor UE(s)' known position, and an indication that gNB/LMF is not involved. If target UE does not know enough anchor UE(s), it includes additionally the identification of all anchor UE(s) known to it and the indication in the initiation message which requests for identification of other anchor UE(s) close to the target UE. The additional indication if target UE does not know enough anchor UE(s) can be sent to any subset of known anchor UE(s) decided by the higher layer in the target UE.

Each anchor UE which receives initiation from target UE sends its response to target UE which includes at least an acceptance of initiation if anchor UE's own position can be known with required accuracy indicated in initiation message, else rejection, If initiation accepted, indication of current SL resources available for positioning signal exchanges with target UE; this can be shared using existing inter-UE coordination framework (with suitable modification) or using a new indication. If requested in initiation message by target UE, identification of other anchor UE(s) close to the target UE and known to this anchor UE, but not already known to the target UE as indicated in the initiation message.

Depending on new anchor UE(s) revealed by anchor UE(s) to which initiation message was sent, target UE sends a request to a subset of initially known anchor UE(s) to forward the initiation message to the additionally revealed anchor UE(s); this request includes identification of anchor UE(s) to which initiation is to be forwarded [new].

Anchor UE(s) which receive the forward request forward the initiation message originally sent by the target UE to the anchor UE(s) indicated in the forward request; the forwarded initiation includes at least:
a. Part indicated in the type of RTT positioning (single-sided or double sided), accuracy requirement for anchor UE(s)' known position, and an indication that gNB/LMF is not involved. of initiation message
b. Identity of target UE

Anchor UE(s) which receive the forwarded initiation reply to anchor UE(s) which forwarded the initiation; the reply includes at least the acceptance of initiation if anchor UE's own position can be known with required accuracy indicated in initiation message, else rejection. If initiation accepted, indication of current SL resources available for positioning signal exchanges with target UE; this can be shared using existing inter-UE coordination framework or using a new method.

Anchor UE(s) which received the forward request from the target UE, forward the reply from the anchor UE(s) to the target UE; this message includes at least the acceptance/rejection and indication of SL resources by the anchor UE(s).

Target UE decides to proceed, terminate or retry multi-RTT depending on the responses received, if the total number of anchor nodes that accepted initiation is less than minimum required, then target UE can retry initiation to anchor UE(s) which rejected multi-RTT request with progressively reduced accuracy requirements up to a certain number of times (set by higher layer of target UE). Retry also follows same two-level procedure as for initial message.

Terminate the flows is proceeded if number of retries exceeded threshold for one or more anchor UE(s) such that minimum number of nodes requirement for multi-RTT cannot be satisfied.

If total number of anchor UE(s) that accepted initiation is greater than or equal to minimum required, then target UE proceeds with multi-RTT and can select any subset of the available anchor UE(s) for further procedure [new].

If target UE decides to proceed with multi-RTT, it allocates SL resources to all selected anchor UE(s) from its SL RP for SL-PRS transmissions and measurement exchange between target UE and anchor UE(s). Target UE and (both in-coverage and out-of-coverage) anchor UE(s) exchange PRS signals and RTT measurements over allocated SL resources. Anchor UE(s) send their respective RTT measurements to the target UE. Target UE computes its own position.

Within a Wireless Communication System many UEs are interacting. Like in FIG. 5 and FIG. 6 illustrated there is as already mentioned, a target UE, and anchor UE(s) initially known to target UE and anchor UE(s) initially unknown to target UE networking.

Target UE sends initiation to known anchor UE(s) including request for identification of additional anchor UE(s) (if required) and checks the received response from known anchor UE(s). Then it sends Send forward request for initiation to (chosen subset of) known anchor UE(s) (if required) and checks to proceed with multi-RTT/Retry/Terminate. Then it sends SL resource allocation for multi-RTT to anchor UE(s) and performs one-sided or two-sided multi-RTT-related SL-PRS transmissions and measurements. It checks the received measurements and if this check is positive is computes the position.

The anchor UE(s) initially known to target UE checks the received request for multi-RTT from target UE? If this check is positive it sends response to target UE (including info on other anchor UE(s) if requested by target UE). Then is check if forward request from target UE is received. If this is correct it forwards initiation for multi-RTT to anchor UE(s) indicated in forward request and checks if response from other anchor UE(s) is received. After that it forwards response by other anchor UE(s) to target UE and checks if the resource allocation from target UE is received. It performs one-sided or two-sided multi-RTT-related SL-PRS transmissions and measurements and sends the measurements to target UE.

The anchor UE(s) initially unknown to target UE checks if the forwarded request for multi-RTT from anchor UE is received and sends the response to anchor UE which forwarded request. After that the anchor UE(s) initially unknown to target UE checks if resource allocation from target UE is received. Then it performs one-sided or two-sided multi-RTT-related SL-PRS transmissions and measurements and sends measurements to target UE.

One preferred embodiment of the methods for sidelink-Aided multi-Round Trip Time Positioning (RTT) without serving gNB involvement in a wireless communication system is characterized by, that single-sided or double-side multi-round trip time (RTT)—of wireless communication signals—based positioning involving the sidelink (SL) in the wireless communication system in coordination with at least is proceeded by using an initiator node and the position of a target user equipment UE is computed.

Another preferred embodiment of the method is characterized by, that single-sided or double-side multi-round trip time (RTT) measurements are performed related to SL-PRS transmissions.

Another preferred embodiment of the method is characterized by, that the anchor UE(s) to be included in the multi-RTT procedure by sharing the accuracy requirement is identified and the multi-RTT procedure is terminated if required by progressively reducing the accuracy requirement.

Another preferred embodiment of the method is characterized by, that an initiator node seeks additional nodes for participation in double-side multi-RTT when there are not enough nodes already known to it.

Another preferred embodiment of the method is characterized by, that the initiator is chosen by a positioning protocol or a higher layer depending on the positioning requirement.

Another preferred embodiment of the method is characterized by, that if an anchor UE requires the position of a target in its vicinity; then the anchor UE can initiate the procedure.

Another preferred embodiment of the method is characterized by, that the anchor UE is a road side unit (RSU).

Another preferred embodiment of the method is characterized by, that the message exchanges between the nodes involved in the multi-RTT procedure are performed over NRPPa/LPP if communication is over the UL or DL.

Another preferred embodiment of the method is characterized by, that message exchanges between the nodes involved in the multi-RTT procedure are performed over a SL positioning protocol or directly using physical layer signaling if communication is over the SL.

Another preferred embodiment of the method is characterized by, that physical layer signaling is SCI and/or PSSCH or MAC CE.

Another preferred embodiment of the method is characterized by, that if the initiator is the target UE the initiation is transmitted to known anchor UE(s); to each known anchor UE, initiation message includes at least: a. type of RTT positioning (single-sided or double sided), accuracy requirement for anchor UE(s)' known position, and an indication that gNB/LMF is not involved and b. if target UE does not know enough anchor UE(s), it includes additionally
i. Identification of all anchor UE(s) known to it
ii. Indication in the initiation message which requests for identification of other anchor UE(s) close to the target UE.

Another preferred embodiment of the method is characterized by, that Type of RTT positioning is single-sided or double sided.

Another preferred embodiment of the method is characterized by, that if the initiator is the anchor UE, whereby target UE and initially known anchor UE (s) are forwarding the initiation to other nodes after receiving direction from the initiating anchor UE.

One preferred embodiment of the invention is characterized by an initiator node which is responsible for identifying the anchor UE(s) to be involved in the multi-RTT positioning and forwarding any resource allocation for positioning to the nodes.

One preferred embodiment of the invention is characterized by a target UE comprises a processor coupled with a memory in which computer program instructions are stored, said instructions being configured to implement steps:
Send initiation to known anchor UE(s) including request for identification of additional anchor UE(s) (if required)
Received response from known anchor UE(s)?
Send forward request for initiation to (chosen subset of) known anchor UE(s) (if required)
Proceed with multi-RTT/Retry/Terminate?
Send SL resource allocation for multi-RTT to anchor UE(s)
Perform one-sided or two-sided multi-RTT-related SL-PRS transmissions and measurements
Received measurements?
Compute position

One preferred embodiment of the invention is characterized by a anchor UE(s) initially known to target UE comprises a processor coupled with a memory in which computer program instructions are stored, said instructions being configured to implement steps
Received request for multi-RTT from target UE?
Send response to target UE (including info on other anchor UE(s) if requested by target UE)
Received forward request from target UE?
Forward initiation for multi-RTT to anchor UE(s) indicated in forward request
Received response from other anchor UE(s)?
Forward response by other anchor UE(s) to target UE
Received resource allocation from target UE?
Perform one-sided or two-sided multi-RTT-related SL-PRS transmissions and measurements
Send measurements to target UE

One preferred embodiment of the invention is characterized by a anchor UE(s) initially unknown to target UE comprises a processor coupled with a memory in which computer program instructions are stored, said instructions being configured to implement steps
Received forwarded request for multi-RTT from anchor UE?
Send response to anchor UE which forwarded request
Received resource allocation from target UE?
Perform one-sided or two-sided multi-RTT-related SL-PRS transmissions and measurements
Send measurements to target UE

A preferred implementation of the invention is a wireless communication system, comprising at least one target UE according to claim 16 and/or 21, target UE according to claim 15, at least one anchor UE(s) initially known to target UE according to claim 16 and at least one anchor UE (s) initially unknown to target UE according to claim 17, being configured to implement steps of claims 1 to 13 whereby within the wireless communication system a initiator according to claim 17 is implemented.

### ABBREVIATIONS

BWP Bandwidth part
CBG Code block group
CLI Cross Link Interference
CP Cyclic prefix
CQI Channel quality indicator
CPU CSI processing unit
CRB Common resource block
CRC Cyclic redundancy check
CRI CSI-RS Resource Indicator
CSI Channel state information
CSI-RS Channel state information reference signal
CSI-RSRP CSI reference signal received power
CSI-RSRQ CSI reference signal received quality
CSI-SINR CSI signal-to-noise and interference ratio
CW Codeword
DCI Downlink control information
DL Downlink
DM-RS Demodulation reference signals
DRX Discontinuous Reception
EPRE Energy per resource element
IAB-MT Integrated Access and Backhaul-Mobile Terminal
L1-RSRP Layer 1 reference signal received power
LI Layer Indicator
MCS Modulation and coding scheme
PDCCH Physical downlink control channel
PDSCH Physical downlink shared channel
PSS Primary Synchronisation signal
PUCCH Physical uplink control channel
QCL Quasi co-location
PMI Precoding Matrix Indicator
PRB Physical resource block
PRG Precoding resource block group
PRS Positioning reference signal
PT-RS Phase-tracking reference signal
RB Resource block
RBG Resource block group
RI Rank Indicator
RIV Resource indicator value
RS Reference signal
SCI Sidelink control information
SLIV Start and length indicator value
SR Scheduling Request
SRS Sounding reference signal
SS Synchronisation signal
SSS Secondary Synchronisation signal
SS-RSRP SS reference signal received power
SS-RSRQ SS reference signal received quality
SS-SINR SS signal-to-noise and interference ratio
TB Transport Block
TCI Transmission Configuration Indicator
TDM Time division multiplexing
UE User equipment
UL Uplink

1. A method for Sidelink-Aided multi-Round Trip Time Positioning (RTT) without serving gNB involvement in a wireless communication system, characterized by, that single-sided or double-side multi-round trip time (RTT)—of wireless communication signals—based positioning involving a sidelink (SL) in the wireless communication system is proceeded by using an initiator node, and a position of a target user equipment UE is computed.

2. The method according to claim 1, whereby single-sided or double-sided multi-round trip time measurements are performed related to SL-PRS transmissions.

3. The method according to claim 1, characterized by, that a plurality of anchor UE(s) to be included in a multi-RTT procedure are identified by sharing an accuracy requirement, and the multi-RTT procedure is terminated, if required, by progressively reducing the accuracy requirement, and a required number of anchor UE(s) are not found.

4. The method according to claim 1, characterized by, that an initiator node seeks additional nodes for participation in double-side multi-RTT when there are not enough nodes already known to it.

5. The method according to claim 1, characterized by, that the initiator is chosen by a positioning protocol or a higher layer depending on the positioning requirement.

6. The method according to claim 5, characterized by, that if an anchor UE requires the position of a target in its vicinity; then the anchor UE can initiate the procedure.

7. The method according to claim 6, characterized by, that the anchor UE is a road side unit (RSU).

8. The method according to claim 1, characterized by, that message exchanges between the nodes involved in the multi-RTT procedure are performed over an SL positioning protocol or directly using signaling over the SL.

9. The method according to claim 8 characterized by, that the signaling over the SL is using the SCI and/or PSSCH and/or MAC CE.

10. The method according to claim 4 characterized by, that if the initiator is the target UE the initiation is transmitted to the anchor UE(s) known to the target UE; the initiation message transmitted to each known anchor UE includes at least:
a. The type of RTT positioning (single-sided or double sided), accuracy requirement for anchor UE(s)' known position, and an indication that gNB/LMF is not involved; and
b. If target UE does not know enough anchor UE(s) for computing its position, it includes additionally
i. Identification of all anchor UE(s) known currently to the target UE, and
ii. An indication in the initiation message, which requests for identification of other anchor UE(s) close to the target UE.

11. The method according to claim 4 characterized by, that the Type of RTT positioning is single-sided or double sided.

12. The method according to claim 4 characterized by, that if the initiator is the anchor UE, whereby target UE and initially known anchor UE(s) are forwarding the initiation to other nodes after receiving direction from the initiating anchor UE.

13. An initiator node which is responsible for identifying one or more anchor UE(s) to be involved in multi round-trip-time positioning and forwarding any resource allocation for positioning to a plurality of nodes.

14. A target UE comprises a processor coupled with a non-transitory memory in which computer program instructions are stored, said instructions being configured to perform operations comprising:
Send initiation to known anchor UE(s) including request for identification of additional anchor UE(s) (if required);
Received response from known anchor UE(s)?;
Send forward request for initiation to (chosen subset of) known anchor UE(s) (if required);
Proceed with multi-RTT/Retry/Terminate?;
Send SL resource allocation for multi-RTT to anchor UE(s);
Perform one-sided or two-sided multi-RTT-related SL-PRS transmissions and measurements;
Received measurements?; and
Compute position.

15. One or more anchor UE(s) initially known to a target UE, each of the one or more anchor UE (s) comprising a respective processor coupled with a respective memory in which respective computer program instructions are stored, said instructions being configured to perform operations comprising:
Received request for multi-RTT from target UE?;
Send response to target UE (including info on other anchor UE(s) if requested by target UE);
Received forward request from target UE?;
Forward initiation for multi-RTT to anchor UE(s) indicated in forward request;
Received response from other anchor UE(s)?;
Forward response by other anchor UE(s) to target UE;
Received resource allocation from target UE?;
Perform one-sided or two-sided multi-RTT-related SL-PRS transmissions and measurements; and
Send measurements to target UE.

16. One or more anchor UE(s) initially unknown to a target UE, each of the one or more anchor US(s) comprising a respective processor coupled with a respective memory in which respective computer program instructions are stored, said instructions being configured to perform operations comprising:
Received forwarded request for multi-RTT from anchor UE?;
Send response to anchor UE which forwarded request;
Received resource allocation from target UE?;
Perform one-sided or two-sided multi-RTT-related SL-PRS transmissions and measurements; and
Send measurements to target UE.

17. (canceled)
